(19) United States
(12) Patent Application Publication
(10) Pub. No.: US 2014/0080544 A1
(43) Pub. Date: Mar. 20, 2014

(54) Method, Apparatus, and System for Controlling Mobile Terminal, and Mobile Terminal

(71) Applicant: Huawei Device Co., Ltd., Shenzhen (CN)

(72) Inventor: Lei Chen, Beijing (CN)

(73) Assignee: Huawei Device Co., Ltd., Shenzhen (CN)

(21) Appl. No.: 14/084,340

(22) Filed: Nov. 19, 2013

Related U.S. Application Data
(63) Continuation of application No. PCT/CN2011/077537, filed on Jul. 25, 2011.

(51) Int. Cl. H04M 1/725

(52) U.S. Cl. CPC H04M 1/72519
USPC 455/557

(57) ABSTRACT

Embodiments of the present invention disclose a method, an apparatus, and a system for controlling a mobile terminal, and a mobile terminal. The method includes: after being successfully connected to the mobile terminal, simulating an earphone wire control key event, and generating control trigger information corresponding to the mobile terminal; and sending the control trigger information to the mobile terminal through an earphone wire control key interface to control the mobile terminal. The apparatus includes a CPU, an earphone output plug, and an earphone wire control key interface, where the CPU includes a generating module and a sending module. The system includes the mobile terminal and the foregoing apparatus for controlling a mobile terminal. In the embodiments, a peripheral controls the mobile terminal by using an earphone interface of the mobile terminal, thereby realizing function extension of the earphone interface of the mobile terminal.

This application is a continuation of International Patent Application No. PCT/CN2011/077537, filed on Jul. 25, 2011, which is hereby incorporated herein by reference in its entirety.

### TECHNICAL FIELD

Embodiments of the present invention relate to communications technologies, and, in particular, to a method, an apparatus, and a system for controlling a mobile terminal, and a mobile terminal.

### BACKGROUND

With the continuing development and maturity of communications technologies, a mobile terminal (for example, a mobile phone) has gradually become a necessity in peoples' life and work, and functions and types of mobile phones are also diversified day by day. At present, basically all mobile phones support a wired earphone function, and an earphone jack on a mobile phone is usually with four sections, which are a left channel, a right channel, a wire control key, and a ground. A wire control function on an earphone is classified into single-key wire control and multi-key wire control; the single-key wire control indicates that there is only one key on the earphone, and is used for implementing simple functions, such as incoming call answering and hanging up; and the multi-key wire control indicates that there is a plurality of keys on the earphone, and is used for implementing multimedia functions, such as a music mobile phone, and may provide a plurality of key functions, such as forward, backward, and pause.

In the prior art, a basic principle of the wire control function on the earphone is: after an earphone wire control key is pressed, a voltage or current on a connection circuit between the mobile phone and the earphone changes, and the change is notified to a CPU of the mobile phone in an interruption manner, and then the CPU of the mobile phone further finishes an operation corresponding to the earphone wire control key.

However, an earphone interface in the prior art implements only control related to an earphone of a mobile phone, which has a certain limitation.

### SUMMARY OF THE INVENTION

Embodiments of the present invention provide a method, an apparatus, and a system for controlling a mobile terminal, and a mobile terminal, which use an earphone interface to implement control of a mobile terminal and realize function extension of an earphone interface on the mobile terminal.

In order to achieve the foregoing objective, an embodiment of the present invention provides a method for controlling a mobile terminal, including after being successfully connected to the mobile terminal, simulating an earphone wire control key event, and generating control trigger information corresponding to the mobile terminal, and sending the control trigger information to the mobile terminal through an earphone wire control key interface to control the mobile terminal.

An embodiment of the present invention provides a method for controlling a mobile terminal, including receiving control trigger information that is sent by a peripheral through an earphone wire control key interface, where the control trigger information is generated by simulating an earphone wire control key event after the peripheral is successfully connected to the mobile terminal and controlling the mobile terminal according to the control trigger information.

An embodiment of the present invention provides an apparatus for controlling a mobile terminal, including a CPU, an earphone output plug, and an earphone wire control key interface, where the CPU includes a generating module, configured to, after the earphone output plug is successfully connected to the mobile terminal, simulate an earphone wire control key event and generate control trigger information corresponding to the mobile terminal and a first sending module, configured to send the control trigger information to the mobile terminal through the earphone wire control key interface to control the mobile terminal.

An embodiment of the present invention provides a mobile terminal, including a first receiving module, configured to receive control trigger information that is sent by a peripheral through an earphone wire control key interface, where the control trigger information is generated by simulating an earphone wire control key event after the peripheral is successfully connected to the mobile terminal and a control module, configured to control the mobile terminal according to the control trigger information.

An embodiment of the present invention provides a system for controlling a mobile terminal, including the foregoing mobile terminal and the foregoing apparatus for controlling the mobile terminal.

With the method, the apparatus, and the system for controlling a mobile terminal and the mobile terminal that are provided in the embodiments of the present invention, after a peripheral is successfully connected to a mobile terminal, the peripheral firstly simulates an earphone wire control key event and generates control trigger information corresponding to the mobile terminal, and then sends the control trigger information to the mobile terminal through an earphone wire control key interface to control the mobile terminal; and in the embodiments, the peripheral controls the mobile terminal by using an earphone interface of the mobile terminal, thereby realizing function extension of the earphone interface on the mobile terminal.

### BRIEF DESCRIPTION OF THE DRAWINGS

To describe the technical solutions in the embodiments of the present invention more clearly, the accompanying drawings required for describing the embodiments or the prior art are briefly described in the following. Apparently, the accompanying drawings in the following description only show some embodiments of the present invention, and persons of ordinary skill in the art may still derive other drawings from these accompanying drawings without creative efforts.

FIG. 1 is a flowchart of a method for controlling a mobile terminal according to a first embodiment of the present invention;

FIG. 2 is a flowchart of a method for controlling a mobile terminal according to a second embodiment of the present invention;

FIG. 3 is a flowchart of a method for controlling a mobile terminal according to a third embodiment of the present invention;

FIG. 4 is a flowchart of a method for controlling a mobile terminal according to a fourth embodiment of the present invention;

FIG. 5 is a structural diagram of an apparatus for controlling a mobile terminal according to a first embodiment of the present invention;

FIG. 6 is a structural diagram of an apparatus for controlling a mobile terminal according to a second embodiment of the present invention;

FIG. 7 is a structural diagram of a mobile terminal according to a first embodiment of the present invention; and

FIG. 8 is a structural diagram of a mobile terminal according to a second embodiment of the present invention.

### DETAILED DESCRIPTION OF ILLUSTRATIVE EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the embodiments to be described are only a part rather than all of the embodiments of the present invention. All other embodiments obtained by persons of ordinary skill in the art based on the embodiments of the present invention without creative efforts shall fall within the protection scope of the present invention.

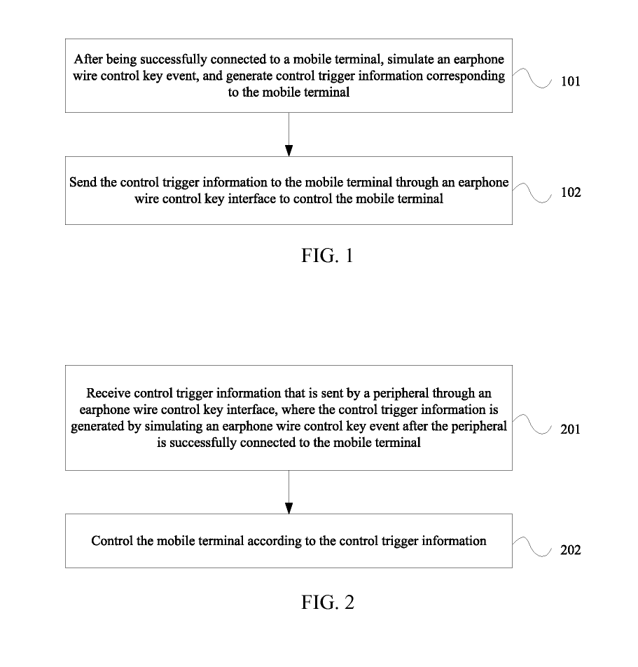

FIG. 1 is a flowchart of a method for controlling a mobile terminal according to a first embodiment of the present invention. As shown in FIG. 1, an embodiment provides a method for controlling a mobile terminal, and in the embodiment, a technical solution of the present invention is described from the side of a peripheral. The embodiment may specifically include the following steps.

Step 101: After being successfully connected to the mobile terminal, simulate an earphone wire control key event, and generate control trigger information corresponding to the mobile terminal.

In the embodiment, the mobile terminal may specifically be a mobile phone, a personal digital assistant (hereinafter referred to as PDA), and so on, and only a mobile phone is taken as an example for description herein. In the embodiment, information and data communication between the mobile terminal and the peripheral is implemented by using an earphone wire control key interface. The peripheral in the embodiment may be a mobile phone hardware unlocking device, a vehicle-mounted bluetooth system, and so on, on which a component with a same structure as that of an earphone plug is set for connecting to an earphone jack on the mobile terminal. Definitely, these peripherals may also be integrated into an earphone of the mobile terminal. In the embodiment, firstly, the peripheral is connected to the earphone jack of the mobile terminal. After the peripheral detects that it is successfully connected to the mobile terminal, the peripheral simulates an earphone wire control key event and generates control trigger information corresponding to the mobile terminal. This step may specifically be implemented by a CPU in the peripheral. In the embodiment, the generated control trigger information is used to trigger or control the mobile terminal, and the generated control trigger information may be decryption information, which is specifically used to unlock the mobile terminal; and the control trigger information may also be interface control information, where the interface control information is used to control a switch of a wireless interface on the mobile terminal, for example, enable a corresponding wireless interface function, and the wireless interface in the embodiment may include a bluetooth interface, a wireless fidelity (referred to as WiFi) interface, and so on. For a different peripheral, generated control trigger information is different, so as to perform a different triggering or controlling operation on the mobile terminal.

Specifically, in the embodiment, the foregoing step 101 may specifically be that: after being successfully connected to the mobile terminal, simulate the earphone wire control key event by controlling an output voltage on an earphone wire control key interface, and generate the control trigger information corresponding to the mobile terminal. In the embodiment, the peripheral simulates the earphone wire control key event by controlling the output voltage on the earphone wire control key interface, that is, in the embodiment, the earphone wire control key event may be triggered without manual participation of a user, so as to generate the control trigger information.

Further, in the embodiment, before the step of simulating the earphone wire control key event, the following step may further be included: Send identification information to the mobile terminal through the earphone wire control key interface, where the identification information is used to identify a device type of the peripheral. After the peripheral is successfully connected to the mobile terminal, the peripheral may firstly send identification information identifying a type of the peripheral to the mobile terminal through the earphone wire control key interface. Correspondence between various peripherals and their identification information may be preset inside the mobile terminal, so that the mobile terminal may learn a type of the connected peripheral according to the identification information and then learn content of the control trigger information that is received subsequently.

Step 102: Send the control trigger information to the mobile terminal through the earphone wire control key interface to control the mobile terminal.

After the peripheral is successfully connected to the mobile terminal and generates the corresponding control trigger information, the peripheral sends the control trigger information to the mobile terminal through the earphone wire control key interface, so as to control the mobile terminal. In the embodiment, the peripheral directly uses the earphone wire control key interface on the mobile terminal to transfer information and data between the peripheral and the mobile terminal. In this way, after receiving the control trigger information, the mobile terminal may perform processing such as decoding, on the control trigger information, and then automatically trigger a corresponding operation according to the processed control trigger information, so that the peripheral controls the mobile terminal.

Specifically, the control trigger information generated in step 101 in the embodiment is different in a different control scenario. For example, it may specifically be an unlocking password, or may specifically be interface control information. In the embodiment, only the two types of control trigger information are taken as an example for description, and persons skilled in the art may understand that it may also be applied to more application scenarios. For a mobile terminal hardware unlocking device, the foregoing step 102 may specifically include the following steps: Send an unlocking password to the mobile terminal through the earphone wire control key interface; and the mobile terminal performs an automatic unlocking operation according to the unlocking password. For a mobile terminal vehicle-mounted bluetooth application, the foregoing step 102 may specifically include the following steps: Send interface control information to the mobile terminal through the earphone wire control key interface; and the mobile terminal automatically performs a corresponding function according to the interface control information.

With the method for controlling a mobile terminal provided in the embodiment, after a peripheral is successfully connected to a mobile terminal, the peripheral firstly generates control trigger information corresponding to the mobile terminal and then sends the control trigger information to the mobile terminal through an earphone wire control key interface to control the mobile terminal; and in the embodiment, the peripheral controls the mobile terminal by using an earphone interface of the mobile terminal, thereby realizing function extension of the earphone interface on the mobile terminal.

FIG. 2 is a flowchart of a method for controlling a mobile terminal according to a second embodiment of the present invention. As shown in FIG. 2, an embodiment provides a method for controlling a mobile terminal, and in the embodiment, a technical solution of the present invention is described from the side of a mobile terminal. The embodiment may specifically include the following steps.

Step 201: Receive control trigger information that is sent by a peripheral through an earphone wire control key interface, where the control trigger information is generated by simulating an earphone wire control key event after the peripheral is successfully connected to the mobile terminal.

This step is that the mobile terminal receives the control trigger information that is sent by the peripheral through the earphone wire control key interface, where the control trigger information is generated by the peripheral by simulating the earphone wire control key event after the peripheral is successfully connected to the mobile terminal.

Further, before step 201, the following steps may further be included: Receive identification information that is sent by the peripheral to the mobile terminal through the earphone wire control key interface; and identify a type of the peripheral according to the identification information. The mobile terminal firstly acquires, through the earphone wire control key interface, identification information sent by the peripheral, and identifies, according to the identification information, a type of the peripheral connected to the mobile terminal, and then receives the control trigger information sent by the peripheral.

Step 202: Control the mobile terminal according to the control trigger information.

The mobile terminal controls its particular function or interface according to the control trigger information after the mobile terminal receives the control trigger information sent by the peripheral.

Specifically, the foregoing step 202 in the embodiment may specifically include the following step: When the received control trigger information is an unlocking password, perform an automatic unlocking operation according to the unlocking password; or when the received control trigger information is interface control information, automatically enable a corresponding interface function according to the interface control information, where the interface control information is used to control a switch of a wireless interface on the mobile terminal. After receiving the identification information sent by the peripheral, the mobile terminal may identify the type of the peripheral according to the identification information and then acquire specific content of the control trigger information that is sent by the peripheral subsequently. When the control trigger information is an unlocking password, the mobile terminal performs an automatic unlocking operation according to the unlocking password; and when the control trigger information is interface control information, the mobile terminal automatically enables a corresponding interface function according to the received control information, such as a bluetooth interface function.

With the method for controlling a mobile terminal provided in the embodiment, a mobile terminal receives control trigger information that is sent by a peripheral through an earphone wire control key interface, and controls the mobile terminal according to the control trigger information, where the control trigger information is generated by simulating an earphone wire control key event after the peripheral is successfully connected to the mobile terminal; and in the embodiment, the peripheral controls the mobile terminal by using an earphone interface of the mobile terminal, thereby realizing function extension of the earphone interface on the mobile terminal.

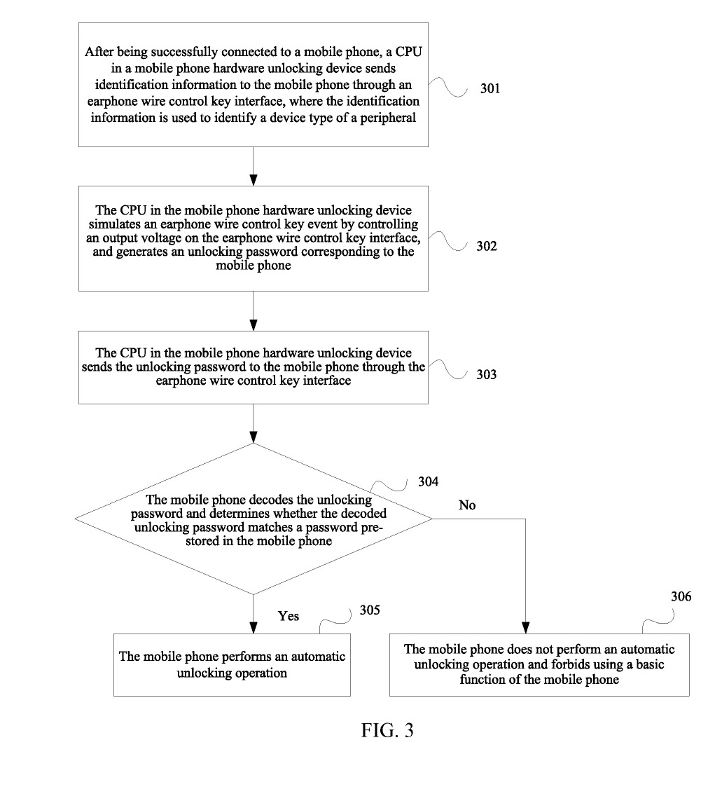

FIG. 3 is a flowchart of a method for controlling a mobile terminal according to a third embodiment of the present invention. As shown in FIG. 3, an embodiment provides a method for controlling a mobile terminal. The embodiment may specifically be applied to a mobile phone hardware unlocking device scenario, and the embodiment may specifically include the following steps.

Step 301: After being successfully connected to a mobile phone, a CPU in a mobile phone hardware unlocking device sends identification information to the mobile phone through an earphone wire control key interface, where the identification information is used to identify a device type of a peripheral.

In the embodiment, the mobile phone hardware unlocking device may be formed by the following parts: a CPU, a standard four-section output plug of an earphone, and an earphone wire control key interface. In the embodiment, when the mobile phone hardware unlocking device plugs in an earphone jack on the mobile phone through the standard four-section output plug of the earphone on the mobile phone hardware unlocking device, and after the CPU in the mobile phone hardware unlocking device detects that it is successfully connected to the mobile phone, the CPU may firstly send identification information that identifies a type of the CPU to the mobile phone through the earphone wire control key interface. Correspondence between various peripherals and their identification information may be preset inside the mobile phone, so that the mobile phone may learn, according to the identification information, that the connected peripheral is a mobile phone hardware unlocking device, and then learn content of control trigger information that is received subsequently.

Step 302: The CPU in the mobile phone hardware unlocking device simulates an earphone wire control key event by controlling an output voltage on the earphone wire control key interface, and generates an unlocking password corresponding to the mobile phone.

In the embodiment, when the CPU in the mobile phone hardware unlocking device detects that it is successfully connected to the mobile phone, the CPU generates an unlocking password corresponding to the mobile phone. Specifically, the CPU controls the output voltage on the earphone wire control key interface through an internally set program, namely, controls an output voltage of an output impedance control circuit of the earphone wire control key interface in the mobile phone hardware unlocking device, so as to simulate a standard earphone wire control key event to generate the unlocking password corresponding to the mobile phone. Specifically, the generated unlocking password in the embodiment may be formed by a key value of an earphone wire control key, a key pressing duration, and a key pressing interval, where the key value indicates a key identifier in a key event simulated by the CPU, the key pressing duration is a duration of pressing the key in the key event, and the key pressing interval is an interval of two consecutive key events. A whole process is completed automatically by the CPU of the mobile phone hardware unlocking device without manual participation of a user. In the embodiment, a standard coding format may be set for the unlocking password. A group of keys is generated based on the key event and the group of keys is coded by using this coding format to generate the unlocking password.

Step 303: The CPU in the mobile phone hardware unlocking device sends the unlocking password to the mobile phone through the earphone wire control key interface.

After the CPU in the mobile phone hardware unlocking device generates the unlocking password, the CPU sends the unlocking password to the mobile phone through the earphone wire control key interface to transfer the unlocking password to the mobile phone.

Step 304: The mobile phone decodes the unlocking password and determines whether the decoded unlocking password matches a password pre-stored in the mobile phone, and if yes, perform step 305, and otherwise, perform step 306.

After receiving the unlocking password, the mobile phone may perform corresponding decoding processing on the unlocking password. Herein, a decoding format corresponding to the coding format in step 302 may specifically be used to decode the received unlocking password. The mobile phone determines whether the decoded unlocking password matches a password pre-stored in the mobile phone, and if the passwords match, perform step 305, and otherwise, perform step 306.

Step 305: The mobile phone performs an automatic unlocking operation.

When the unlocking password received by the mobile phone from the mobile phone hardware unlocking device matches the password pre-stored in the mobile phone, it indicates that the mobile phone hardware unlocking device is an unlocking device uniquely corresponding to the mobile phone. Then, the mobile phone performs an automatic unlocking operation so that the mobile phone may be used properly, thereby implementing unlocking control over the mobile phone through the mobile phone hardware unlocking device.

Step 306: The mobile phone does not perform an automatic unlocking operation and forbids using a basic function of the mobile phone.

When the unlocking password received by the mobile phone from the mobile phone hardware unlocking device does not match the password pre-stored in the mobile phone, it indicates that the mobile phone hardware unlocking device is not an unlocking device uniquely corresponding to the mobile phone. Then, the mobile phone does not perform an automatic unlocking operation and forbids using a basic function of the mobile phone. The mobile phone is in a locked status, which ensures mobile phone security to a greatest extent.

With the method for controlling a mobile terminal provided in the embodiment, after a mobile phone hardware unlocking device is successfully connected to a mobile phone, the mobile phone hardware unlocking device firstly simulates an earphone wire control key event and generates an unlocking password corresponding to the mobile phone, and then sends the unlocking password to the mobile phone through an earphone wire control key interface to perform unlocking control on the mobile phone; and in the embodiment, the mobile phone hardware unlocking device controls the mobile phone by using an earphone interface of the mobile phone, thereby realizing function extension of the earphone interface on the mobile phone.

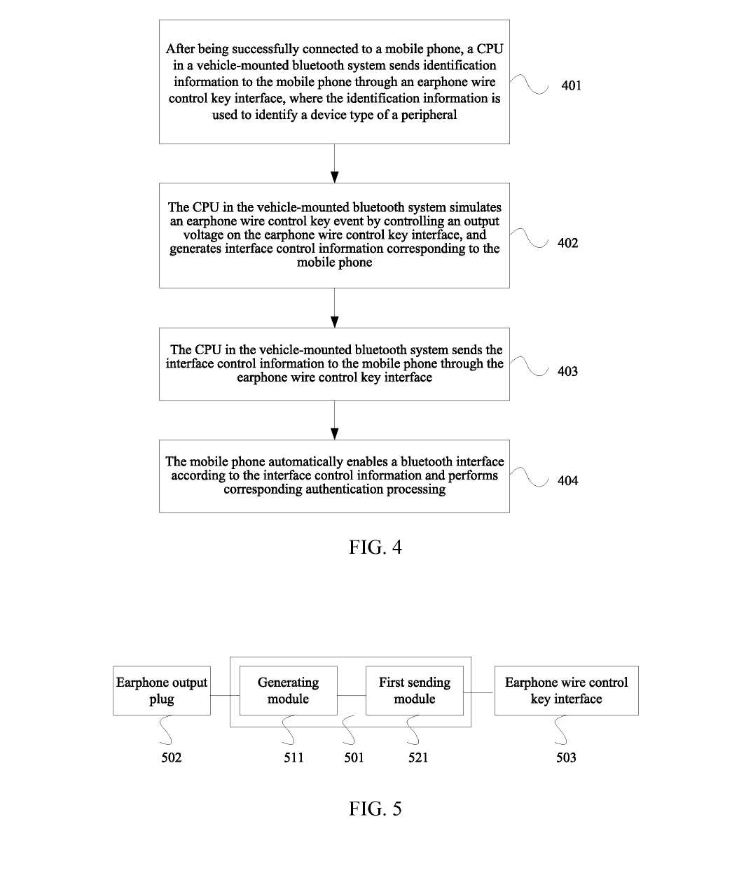

FIG. 4 is a flowchart of a method for controlling a mobile terminal according to a fourth embodiment of the present invention. As shown in FIG. 4, an embodiment provides a method for controlling a mobile terminal. The embodiment may specifically be applied to a vehicle-mounted bluetooth application scenario, and the embodiment may specifically include the following steps.

Step 401: After being successfully connected to a mobile phone, a CPU in a vehicle-mounted bluetooth system sends identification information to the mobile phone through an earphone wire control key interface, where the identification information is used to identify a device type of a peripheral.

In the embodiment, the vehicle-mounted bluetooth system may be formed by the following parts: a CPU, a standard four-section output plug of an earphone, and an earphone wire control key interface. In the embodiment, when the vehicle-mounted bluetooth system plugs in an earphone jack on the mobile phone through the standard four-section output plug of the earphone on the vehicle-mounted bluetooth system, and after the CPU in the vehicle-mounted bluetooth system detects that it is successfully connected to the mobile phone, the CPU may firstly send identification information that identifies a type of the CPU to the mobile phone through the earphone wire control key interface, so that the mobile phone may learn, according to the identification information, that the connected peripheral is a vehicle-mounted bluetooth system, and then learn content of control trigger information that is received subsequently.

Step 402: The CPU in the vehicle-mounted bluetooth system simulates an earphone wire control key event by controlling an output voltage on the earphone wire control key interface, and generates interface control information corresponding to the mobile phone.

In the embodiment, when the CPU in the vehicle-mounted bluetooth system detects that it is successfully connected to the mobile phone, the CPU generates interface control information corresponding to the mobile phone, where the interface control information in the embodiment is specifically used to control a switch of a wireless interface on the mobile terminal, and the wireless interface is specifically a bluetooth interface. Specifically, the CPU controls the output voltage on the earphone wire control key interface through an internally set program to simulate a standard earphone wire control key event and generate the interface control information corresponding to the mobile phone. Specifically, the generated interface control information in the embodiment may also be formed by a key value of an earphone wire control key, a key pressing duration, and a key pressing interval. A whole process is completed automatically by the CPU in the vehicle-mounted Bluetooth system without manual participation of a user.

Step 403: The CPU in the vehicle-mounted bluetooth system sends the interface control information to the mobile phone through the earphone wire control key interface.

After generating the interface control information, the CPU in the vehicle-mounted bluetooth system sends the interface control information to the mobile phone through the earphone wire control key interface to transfer the interface control information to the mobile phone.

Step 404: The mobile phone automatically enables a bluetooth interface according to the interface control information and performs corresponding authentication processing.

After the mobile phone receives the interface control information, the mobile phone automatically enables a bluetooth interface. Then, the mobile phone performs corresponding authentication processing according to the interface control information, which may specifically be that the mobile phone performs an operation such as authentication with the vehicle-mounted bluetooth system according to an authentication password carried in the interface control information.

It should be noted that, that the method for controlling a mobile terminal is applied to the vehicle-mounted bluetooth system is taken as an example for description in the embodiment, and persons skilled in the art may understand that the method may also be applied to other similar interface systems. For example, it is applied to a WiFi interface system, and used to automatically trigger the enabling of a WiFi interface.

With the method for controlling a mobile terminal provided in the embodiment, after a vehicle-mounted bluetooth system is successfully connected to a mobile phone, the vehicle-mounted bluetooth system firstly simulates an earphone wire control key event and generates interface control information corresponding to the mobile phone, and then sends the interface control information to the mobile phone through an earphone wire control key interface to automatically enable a bluetooth interface of the mobile phone; and in the embodiment, the vehicle-mounted bluetooth system controls the mobile phone by using an earphone interface of the mobile phone, thereby realizing function extension of the earphone interface on the mobile phone.

Persons of ordinary skill in the art may understand that all or a part of the steps of the foregoing method embodiments may be implemented by a program instructing relevant hardware. The foregoing program may be stored in a computer readable storage medium. When the program runs, the steps of the foregoing method embodiments are performed; and the foregoing storage medium may be any medium capable of storing program codes, such as a ROM, a RAM, a magnetic disk, or an optical disk.

FIG. 5 is a structural diagram of an apparatus for controlling a mobile terminal according to a first embodiment of the present invention. As shown in FIG. 5, an embodiment provides an apparatus for controlling a mobile terminal, which may specifically perform the steps in the first method embodiment, which is not described herein again. The apparatus for controlling a mobile terminal provided in the embodiment may specifically include a CPU 501, an earphone output plug 502, and an earphone wire control key interface 503, where the CPU 501 includes a generating module 511 and a first sending module 521. The generating module 511 is configured to, after the earphone output plug is successfully connected to the mobile terminal, simulate an earphone wire control key event and generate control trigger information corresponding to the mobile terminal. The first sending module 521 is configured to send the control trigger information to the mobile terminal through the earphone wire control key interface to control the mobile terminal.

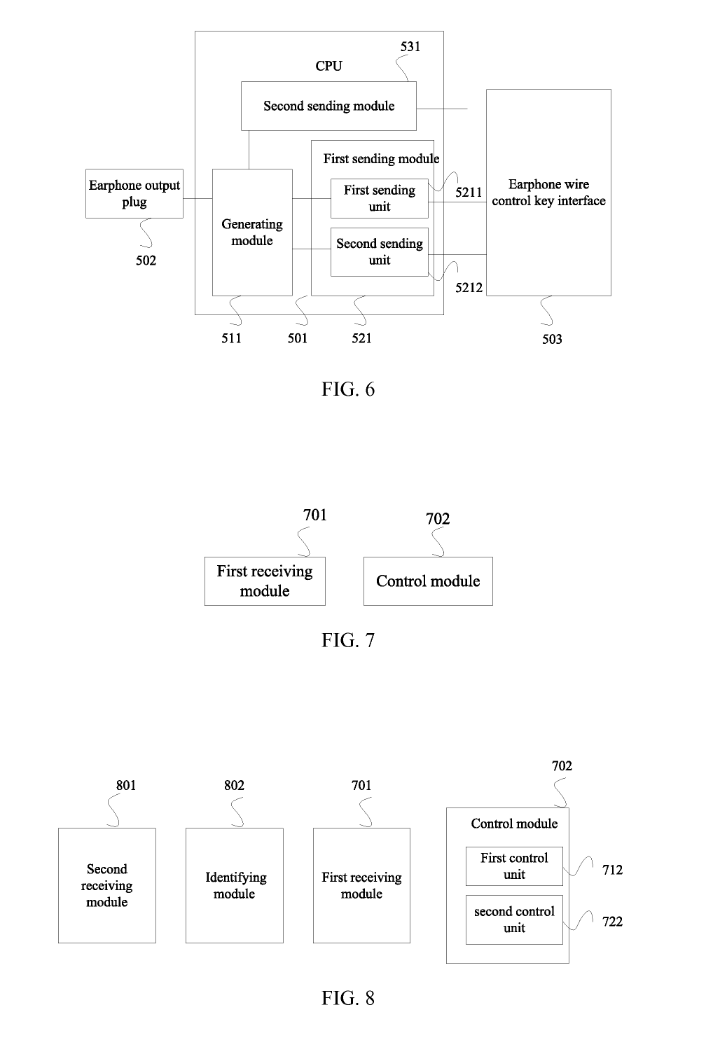

FIG. 6 is a structural diagram of an apparatus for controlling a mobile terminal according to a second embodiment of the present invention. As shown in FIG. 6, an embodiment provides an apparatus for controlling a mobile terminal, which may specifically perform the steps in the third or fourth method embodiment, which is not described herein again. On the basis of the apparatus for controlling a mobile terminal provided in the embodiment shown in FIG. 5, the generating module 511 may specifically be configured to, after the earphone output plug is successfully connected to the mobile terminal, simulate the earphone wire control key event by controlling an output voltage on the earphone wire control key interface and generate the control trigger information corresponding to the mobile terminal.

Further, a CPU in the apparatus for controlling a mobile terminal provided in the embodiment may further include: a second sending module 531, where the second sending module 531 is configured to send identification information to the mobile terminal through the earphone wire control key interface before the generating module 511 simulates the earphone wire control key event, where the identification information is used to identify a device type of a peripheral.

Specifically, the first sending module 521 in the embodiment may specifically include a first sending unit 5211, where the first sending unit 5211 is configured to send an unlocking password to the mobile terminal through the earphone wire control key interface, and the mobile terminal performs an automatic unlocking operation according to the unlocking password.

Further, the sending module 521 in the embodiment may specifically include a second sending unit 5212, where the second sending unit 5212 is configured to send interface control information to the mobile terminal through the earphone wire control key interface, where the interface control information is used to control a switch of a wireless interface on the mobile terminal, and the mobile terminal automatically enables a corresponding interface function according to the interface control information.

The apparatus for controlling a mobile terminal provided in the embodiment, after being successfully connected to a mobile terminal, firstly simulates an earphone wire control key event and generates control trigger information corresponding to the mobile terminal, and then sends the control trigger information to the mobile terminal through an earphone wire control key interface to control the mobile terminal; and in the embodiment, a peripheral controls the mobile terminal by using an earphone interface of the mobile terminal, thereby realizing function extension of the earphone interface on the mobile terminal.

FIG. 7 is a structural diagram of a mobile terminal according to a first embodiment of the present invention. As shown in FIG. 7, an embodiment provides a mobile terminal, which may specifically perform the steps in the second method embodiment, which is not described herein again. The mobile terminal provided in the embodiment may specifically include a first receiving module 701 and a control module 702. The first receiving module 701 is configured to receive control trigger information that is sent by a peripheral through an earphone wire control key interface, where the control trigger information is generated by simulating an earphone wire control key event after the peripheral is successfully connected to the mobile terminal. The control module 702 is configured to control the mobile terminal according to the control trigger information.

FIG. 8 is a structural diagram of a mobile terminal according to a second embodiment of the present invention. As shown in FIG. 8, an embodiment provides a mobile terminal, which may specifically perform the steps in the third or fourth method embodiment, which is not described herein again. The mobile terminal provided in the embodiment, on the basis of FIG. 7, may further include a second receiving module 801 and an identifying module 802. The second receiving module 801 is configured to, before the first receiving module 701 receives the control trigger information that is sent by the peripheral through the earphone wire control key interface, receive identification information that is sent by the peripheral to the mobile terminal through the earphone wire control key interface. The identifying module 802 is configured to identify a type of the peripheral according to the identification information.

Specifically, the control module 702 provided in the embodiment may specifically include a first control unit 712 or a second control unit 722. The first control unit 712 is configured to, when the received control trigger information is an unlocking password, perform an automatic unlocking operation according to the unlocking password. The second control unit 722 is configured to, when the received control trigger information is interface control information, automatically enable a corresponding interface function according to the interface control information, where the interface control information is used to control a switch of a wireless interface on the mobile terminal.

The mobile terminal provided in the embodiment receives control trigger information that is sent by a peripheral through an earphone wire control key interface, and controls the mobile terminal according to the control trigger information, where the control trigger information is generated by simulating an earphone wire control key event after the peripheral is successfully connected to the mobile terminal; and in the embodiment, the peripheral controls the mobile terminal by using an earphone interface of the mobile terminal, thereby realizing function extension of the earphone interface on the mobile terminal.

An embodiment further provides a system for controlling a mobile terminal, which may specifically include the apparatus for controlling a mobile terminal shown in FIG. 5 or FIG. 6 and the mobile terminal shown in FIG. 7 or FIG. 8.

Finally, it should be noted that, the foregoing embodiments are only provided for describing the technical solutions of the present invention, but are not intended to limit the present invention. It should be understood by persons of ordinary skills in the art that although the present invention is described in detail with reference to the embodiments, modifications may still be made to the technical solutions described in the foregoing embodiments, or equivalent replacements may be made to some technical features in the technical solutions, as long as such modifications or replacements do not cause the essence of corresponding technical solutions to depart from the spirit and scope of the technical solutions in the embodiments of the present invention.

What is claimed is:

1. A method for controlling a mobile terminal, comprising:
simulating an earphone wire control key event, and generating control trigger information corresponding to the mobile terminal after being successfully connected to the mobile terminal,; and
sending the control trigger information to the mobile terminal through an earphone wire control key interface to control the mobile terminal.

2. The method according to claim 1, wherein the simulating an earphone wire control key event, and generating control trigger information corresponding to the mobile terminal after being successfully connected to a mobile terminal comprises:
simulating the earphone wire control key event by controlling an output voltage on the earphone wire control key interface, and generating the control trigger information corresponding to the mobile terminal after being successfully connected to the mobile terminal.

3. The method according to claim 1, wherein before the simulating an earphone wire control key event, the method further comprises:
sending identification information to the mobile terminal through the earphone wire control key interface, wherein the identification information is configured to identify a device type of a peripheral.

4. The method according to claim 1 wherein the sending the control trigger information to the mobile terminal through an earphone wire control key interface to control the mobile terminal comprises:
sending an unlocking password to the mobile terminal through the earphone wire control key interface; and
performing, by the mobile terminal, an automatic unlocking operation according to the unlocking password.

5. The method according to claim 1, wherein the sending the control trigger information to the mobile terminal through an earphone wire control key interface to control the mobile terminal comprises:
sending interface control information to the mobile terminal through the earphone wire control key interface, wherein the interface control information is configured to control a switch of a wireless interface on the mobile terminal; and
enabling, by the mobile terminal, a corresponding interface function according to the interface control information.

6. The method according to claim 1, wherein the control trigger information is formed by a key value of an earphone wire control key, a key pressing duration, and a key pressing interval.

7. A method for controlling a mobile terminal, comprising:
receiving control trigger information that is sent by a peripheral through an earphone wire control key interface, wherein the control trigger information is generated by simulating an earphone wire control key event by the peripheral after the peripheral is successfully connected to the mobile terminal; and
controlling the mobile terminal according to the control trigger information.

8. The method according to claim 7, wherein before the receiving control trigger information that is sent by a peripheral through an earphone wire control key interface, the method further comprises:
receiving identification information that is sent by the peripheral to the mobile terminal through the earphone wire control key interface; and
identifying a type of the peripheral according to the identification information.

9. The method according to claim 8, wherein the controlling the mobile terminal according to the control trigger information comprises:
when the received control trigger information is an unlocking password, performing an automatic unlocking operation according to the unlocking password.

10. The method according to claim 8, wherein the controlling the mobile terminal according to the control trigger information comprises:
when the received control trigger information is interface control information, automatically enabling a corresponding interface function according to the interface control information, wherein the interface control information is used to control a switch of a wireless interface on the mobile terminal.

11. The method according to claim 7, wherein the controlling the mobile terminal according to the control trigger information comprises:
when the received control trigger information is an unlocking password, performing an automatic unlocking operation according to the unlocking password.

12. The method according to claim 7, wherein the controlling the mobile terminal according to the control trigger information comprises:
when the received control trigger information is interface control information, automatically enabling a corresponding interface function according to the interface control information, wherein the interface control information is used to control a switch of a wireless interface on the mobile terminal.

13. An apparatus for controlling a mobile terminal, comprising a CPU, an earphone output plug, and an earphone wire control key interface, wherein the CPU comprises:
a generating module, configured to simulate an earphone wire control key event and generate control trigger information corresponding to the mobile terminal after the earphone output plug is successfully connected to the mobile terminal; and
a first sending module, configured to send the control trigger information to the mobile terminal through the earphone wire control key interface to control the mobile terminal.

14. The apparatus according to claim 13, wherein the generating module is specifically configured to, simulate the earphone wire control key event by controlling an output voltage on the earphone wire control key interface and generate the control trigger information corresponding to the mobile terminal after the earphone output plug is successfully connected to the mobile terminal.

15. The apparatus according to claim 13, wherein the CPU further comprises:
a second sending module, configured to send identification information to the mobile terminal through the earphone wire control key interface before the generating module simulates the earphone wire control key event, wherein the identification information is configured to identify a device type of a peripheral.

16. The apparatus according to claim 13, wherein the first sending module comprises:
a first sending unit, configured to send an unlocking password to the mobile terminal through the earphone wire control key interface, wherein the mobile terminal performs an automatic unlocking operation according to the unlocking password.

17. The apparatus according to claim 13, wherein the first sending module comprises:
a second sending unit, configured to send interface control information to the mobile terminal through the earphone wire control key interface, wherein the interface control information is configured to control a switch of a wireless interface on the mobile terminal, and the mobile terminal automatically enables a corresponding interface function according to the interface control information.

18. A mobile terminal, comprising:
a first receiving module, configured to receive control trigger information that is sent by a peripheral through an earphone wire control key interface, wherein the control trigger information is generated by simulating an earphone wire control key event after the peripheral is successfully connected to the mobile terminal are; and
a control module, configured to control the mobile terminal according to the control trigger information.

19. The mobile terminal according to claim 18, further comprising:
a second receiving module, configured to, before the first receiving module receives the control trigger information that is sent by the peripheral through the earphone wire control key interface, receive identification information that is sent by the peripheral to the mobile terminal through the earphone wire control key interface; and
an identifying module, configured to identify a type of the peripheral according to the identification information.

20. The mobile terminal according to claim 19, wherein the control module comprises:
a first control unit, configured to, when the received control trigger information is an unlocking password, perform an automatic unlocking operation according to the unlocking password.

21. The mobile terminal according to claim 19, wherein the control module comprises:
a second control unit, configured to, when the received control trigger information is interface control information, automatically enable a corresponding interface function according to the interface control information, wherein the interface control information is used to control a switch of a wireless interface on the mobile terminal.

22. The mobile terminal according to claim 18, wherein the control module comprises:
a first control unit, configured to, when the received control trigger information is an unlocking password, perform an automatic unlocking operation according to the unlocking password.

23. The mobile terminal according to claim 18, wherein the control module comprises:
a second control unit, configured to, when the received control trigger information is interface control information, automatically enable a corresponding interface function according to the interface control information, wherein the interface control information is used to control a switch of a wireless interface on the mobile terminal.

24. A system for controlling a mobile terminal, comprising the apparatus for controlling a mobile terminal and the mobile terminal, wherein the apparatus comprises a CPU, an earphone output plug, and an earphone wire control key interface, wherein the CPU comprises a generating module, configured to simulate an earphone wire control key event and generate control trigger information corresponding to the mobile terminal after the earphone output plug is successfully connected to the mobile terminal; and a first sending module, configured to send the control trigger information to the mobile terminal through the earphone wire control key interface to control the mobile terminal;
the mobile terminal comprises a first receiving module, configured to receive control trigger information that is sent by a peripheral through an earphone wire control key interface, wherein the control trigger information is generated by simulating an earphone wire control key event after the peripheral is successfully connected to the mobile terminal are; and a control module, configured to control the mobile terminal according to the control trigger information.
